(19) United States
(12) Patent Application Publication
(10) Pub. No.: US 2003/0180598 A1
(43) Pub. Date: Sep. 25, 2003

(54) Bipolar plate for pem fuel cells

(76) Inventors: Klaus Fischer, Ludwigshafen (DE); Willi Bartholomeyzik, Hassloch (DE)

Correspondence Address: Keil & Weinkauf, 1101 Connecticut Avenue NW, Washington, DC, 20036, US

(21) Appl. No.: 10/344,518

(22) PCT Filed: Aug. 14, 2001
(86) PCT No.: PCT/EP01/09385

(30) Foreign Application Priority Data
Aug. 14, 2000 (DE) 10039674.7

(51) Int. Cl. H01M 8/02; B32B 15/08

(52) U.S. Cl. 429/34; 428/458

(57) ABSTRACT

Described are a bipolar plate for PEM fuel cells comprising a core metal layer and two nonconductive plastic layers bilaterally overlying the metal layer and enclosing it, which form the surfaces of the bipolar plates, wherein the metal layer has one or more electroconductive connections to both surfaces and the plastic layers are equipped with superficial gas transport channels, and a bipolar plate for PEM fuel cells made of nonconductive plastic which is equipped on both surfaces with gas transport channels and which, except for its edge region, is metal coated, the bilateral metal coatings being electroconductively connected through the plastic via one or more metal contacting means.

The invention relates to bipolar plates for PEM fuel cells, their fabrication and use in fuel cell stacks and to their application as a power supply in mobile and stationary apparatuses.

The predominant means of propulsion which have been used hitherto in motor vehicles are internal combustion engines which require petroleum products as a fuel. As petroleum resources are limited and the combustion products can have a negative impact on the environment, recent years have seen increasing research into alternative propulsion schemes.

In this context, utilization of electrochemical fuel cells for mobile and stationary power supplies is becoming more and more interesting.

Currently in existence are various types of fuel cells whose mode of operation is generally based on the electrochemical recombination of hydrogen and oxygen to produce the end product water. They can be categorized in terms of the conductive electrolyte used, the operating temperature level and achievable output ranges. Particularly suitable for use in motor vehicles are polymer electrolyte membrane fuel cells (PEM fuel cells, sometimes abbreviated as PEFC). They are usually operated at from 50 to 90° C. and currently, in a complete stack, supply electrical power in a range of from 1 to 75 kW (passenger car) and up to 250 kW (commercial vehicle, bus).

In a PEM fuel cell, the electrochemical reaction of hydrogen with oxygen to produce water is subdivided, by the insertion of a proton-conducting membrane between the anode electrode and the cathode electrode, into the two substeps reduction and oxidation. These give rise to a charge separation which can be utilized as a voltage source. Fuel cells of this type are summarized, for example, in “Brennstoffzellen-Antrieb, innovative Antriebkonzepte, Komponenten und Rahmenbedingungen” [Fuel Cell Propulsion, Innovative Propulsion Schemes, Components and Constraints], paper for the symposium of IIR Deutschland GmbH, May 29 to 31, 2000 in Stuttgart.

An individual PEM fuel cell is of symmetric design. A polymer membrane is followed on both sides by a catalyst layer and gas distributor layer which is adjoined by a bipolar plate.

Current collectors are used to take off the voltage, while end plates ensure that the reaction gases are metered in and the reaction products are removed.

In such an arrangement, the bipolar plate connects two cells mechanically and electrically. As the voltage of an individual cell is in the range around 1 V, practical applications require numerous cells to be connected in series. Often, up to 150 cells, separated by bipolar plates, are stacked on top of one another, in such a way, that the oxygen side of one cell is connected to the hydrogen side of the next cell via the bipolar plate. In such an arrangement, the bipolar plate satisfies a number of functions. It serves for electrical interconnection of the cells, to supply and distribute reactants (reaction gases) and coolants and to separate the gas compartments. In so doing, a bipolar plate must satisfy the following characteristics:

chemical resistance to humid oxidizing and reducing conditions

gas-tightness

high conductivity

low contact resistances

dimensional stability

low cost in terms of material and fabrication

freedom in terms of design

high mechanical stability under load

corrosion resistance

low weight.

At present, three different types of bipolar plates are in use. Firstly, metallic bipolar plates are used which are composed, for example, of alloy steels or coated other materials such as aluminum or titanium.

Metallic materials are distinguished by high gas-tightness, dimensional stability and high electrical conductivity.

Graphitic bipolar plates can be suitably shaped by compression molding or milling. They are distinguished by chemical resistance and low contact resistances, but in addition to high weight have inadequate mechanical properties. Composite materials are composed of special plastics which include conductive fillers, e.g. carbon-based.

WO 98/33224 describes bipolar plates made of iron alloys which include high proportions of chromium and nickel.

GB-A-2 326 017 discloses bipolar plates made of plastic material which are rendered conductive by electro-conductive fillers such as powdered carbon. In addition, a superficial metal coating may be present which enables an electroconductive connection, via the edges of the bipolar plate, between two cells.

According to WO 98/53514, a polymer resin is treated by the introduction of an electroconductive powder and a hydrophilizing agent. Polymer compounds filled with silicon dioxide particles and graphite powder are used as bipolar plates. Used in particular in this context are phenol resins.

DE-A 196 02 315 relates to liquid cooled fuel cells having distribution channels in the cell surface. The cell surface may be composed of different materials according to their function. The separators can be made of graphite, titan and/or metal alloys, for example. To equalize the current transfer fabrics or nets are employed which are made from materials which are similar to those of which the separators are formed. The frame areas are made of plastics, for example.

U.S. Pat. No. 5,776,624 discloses a bipolar plate made from metal layers which have been soldered. Between the metal sheets there are provided channels for cooling media. The layers are connected to each other in a current conductive manner by a soldering metal, preferably Ni-alloys.

U.S. Pat. No. 6,071,635 relates to plates, for example bipolar plates, through which liquids or gases flow. The plates are made from conductive and non-conductive materials. These materials form parts of the connector areas and/or channels on the surfaces of the plate. The conductive materials form electrical circuits on the surface of the plate, and the non-conductive materials can have reinforcements and/or sealings of the channels or parts of the periphery of the plate surface. They can be injection-molded.

As bipolar plates are critical functional elements of PEM fuel cell stacks, which make a considerable contribution to the costs and the weight of the stacks, there is great demand for bipolar plates which satisfy the abovementioned specification profile while avoiding the drawbacks of the known bipolar plates.

In particular, it is an object of the invention to enable uncomplicated and cost-effective fabrication of bipolar plates.

We have found that this object is achieved according to the invention by a bipolar plate for PEM fuel cells comprising a core metal layer and two nonconductive plastic layers bilaterally overlying the metal layer and enclosing it, which form the surfaces of the bipolar plates, wherein the metal layer having one or more electroconductive connections to both surfaces and the plastic layers being equipped with superficial gas transport channels.

The object is further achieved by a bipolar plate for PEM fuel cells made of nonconductive plastic which is equipped on both surfaces with gas transport channels and which, except for its edge region, is metal coated, the bilateral metal coatings being electroconductively connected through the plastic via one or more metal contacting means.

In such an arrangement, the plastic layers in the first-mentioned bipolar plate can on both surfaces, except for their edge regions, be equipped with metal coatings which are electroconductively connected to the electroconductive connections.

According to the invention, the design of the bipolar plate involves a separation of the functions of the geometry (design of the gas channels) and of the electroconductive structures. The conductivity function in such an arrangement can be achieved either by a metal circuit board (core metal layer) being encapsulated or by an injection molding or part of the surface of the injection molding being subsequently metalized.

As a result of the functions being separated according to the invention it is possible for the conductive bipolar plate to be fabricated considerably more cost-effectively. The use of two components comprises the option of optimizing each individual component in terms of its function and materials characteristics.

The bipolar plate according to the invention generally is of sheet-like design and consequently has two surfaces opposite one another. In the edge region, the bipolar plates, together with other components of the fuel cells, are pressed together to form stacks. Consequently, the bipolar plates according to the invention do not have metal coatings in said edge regions of the surface, but instead are fitted with means suitable for gas-tightly joining the bipolar plates to the other components of the cells or are designed to accommodate such means. The term “edge region” refers precisely to that edge region of the surfaces which is required to join the bipolar plates to the other components of the fuel cells.

According to a first embodiment of the invention, the bipolar plate has a core metal layer (circuit board) and two nonconductive plastic layers bilaterally overlying the metal layer and enclosing it. Said core metal layer (circuit board) can have any suitable geometry. For example, it can be a lamina or a foil, which is equipped with electroconductive connections to both surfaces. For example, it can be a foil or a lamina in which projecting features such as fins, lugs, nubs etc. are provided which extend as far as the surface of the plastic layers. Alternatively, the metal layer can be in the form of a grid, knit, woven or some other geometry, as long as it provides an electroconductive connection between the two surfaces of the plastic layers. The thickness and makeup of said metal layer can be freely chosen as long as an adequate conductivity is achieved which prevents a maximum desired contact resistance from being exceeded.

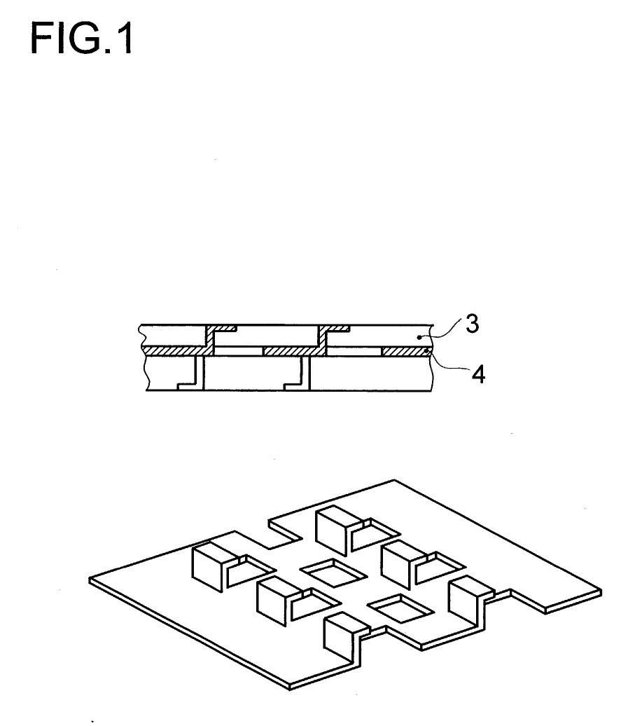

Such a design of the metal layer is shown in FIG. 1 in a perspective view and as a cross-sectional view. On both sides, the metal layer has projecting lugs which extend as far as the surface of the plastic layer applied subsequently.

At the same time, the plastic structure in its surface region has the necessary gas transport channels.

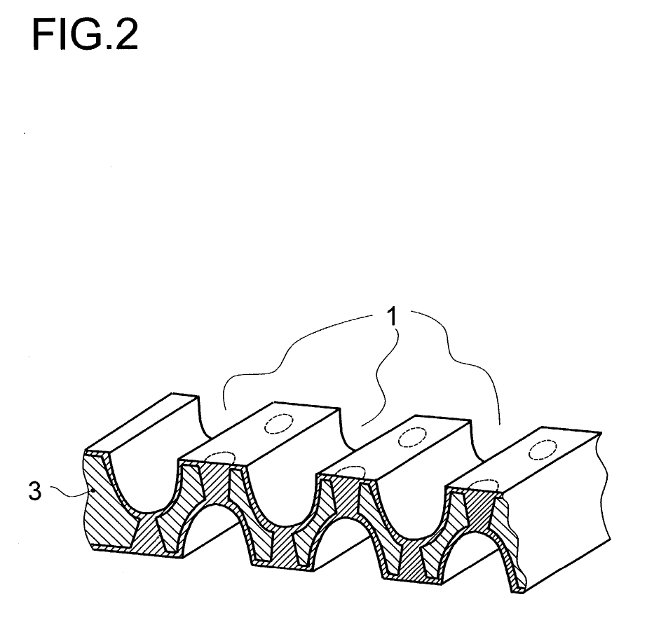

According to the second embodiment of the invention, the bipolar plate is composed of a nonconductive plastic, the plate having metal coatings on both surfaces. The border regions or edge regions of the plate in this case have no such metal coatings, so that the two surfaces are not conductively connected to one another across the edges of the plate. The electro-conductive connection of the two surface coatings is ensured by metal contacting means which connect the bilateral metal layers through the plastic. FIG. 2 shows a bipolar plate of this type in a perspective and partially in a cross-sectional view.

The bipolar plate made of plastics usually has a plate thickness of more than 2 mm. Preferably, the plate thickness is 2.1 mm to 5.0 mm, especially preferred 2.5 mm to 3.5 mm. The layer thickness of the metal coatings is usually 0.05 mm to 0.1 mm, preferably 0.12 to 0.15 mm. The plate thicknesses of bipolar plates used hitherto are usually around 5 mm. Thus, due to the multitude of single plates which are employed in a fuel cell stack, according to the present invention the reduction of the plate thickness and the use of plastics instead of for example graphite in the bipolar plates according to the present invention the total weight and the space occupied by the fuel cell can be reduced to a large extent.

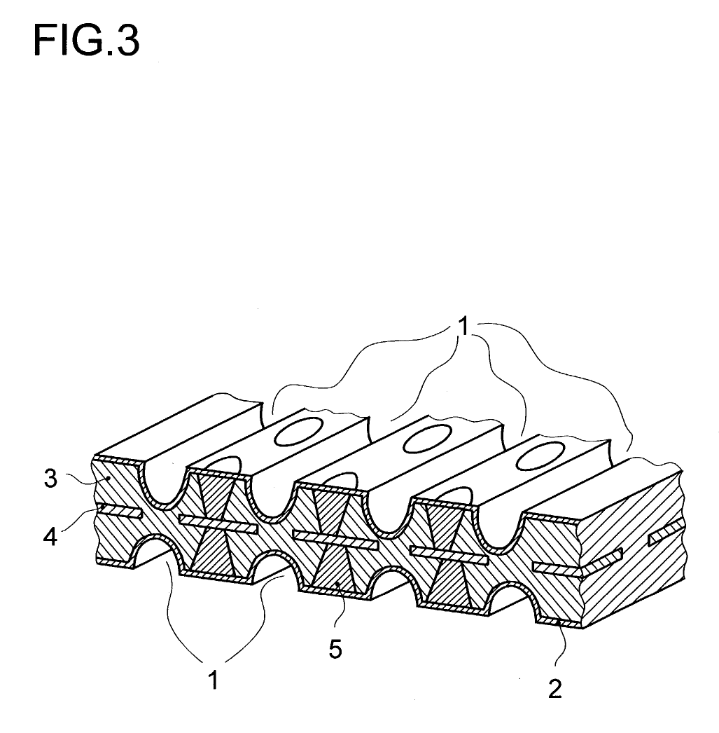

It is also possible for the two embodiments of the bipolar plate to be combined, as shown in FIG. 3, the core metal layer being designed as a perforated metal plate. The plastic layer surrounding the metal layer is equipped with gas channels on both surfaces. In addition, the surface is provided with a conductive coating which is connected to the metal layer via contacting means.

The geometries shown in the FIGS. 1 to 3 are examples of a large number of possible design variations, the reference symbols in the figures having the following meanings:

1 Gas channels

2 Conductive coating

3 Plastic material

4 Metal layer, e.g. (perforated) metal plate

5 Electroconductive connection (contacting means).

The number of electroconductive connections present at the surface of the bipolar plate is freely chosen on the basis of practical requirements. For example, the size and number of the connections chosen are such that the volume resistance of the bipolar plate does not become excessively large. Moreover, a good electro-conductive connection to the gas distributor layers (e.g. graphite paper) lying against the bipolar plate should be ensured.

Suitable for use as a plastic material according to the invention, are all reinforced and nonreinforced thermo-plastics or thermosetting plastics which are chemically stable against humid, oxidizing and reducing conditions as prevail in PEM fuel cells. Additionally, they should be gas-tight and dimensionally stable. Examples of suitable materials are polyamides, polybutyleneterephthalates, polyoxymethylene, polysulfone, polyethersulfone, polyphenyleneoxide, polyetherketone, polypropylene, polyester, ethylene-propylene-copolymers, unsaturated polyesterresins, phenol-formaldehyde-resins and other engineering plastics.

Further more, blends of the listed plastics are suitable as well, as well as fibre and mineral reinforced plastics.

Suitable for the metallic surface layer are, e.g., all corrosion-resistant metals such as Cr, Ni, Cu, Mo, Pb, Ti, V or alternatively graphite. They can be applied in accordance with any suitable techniques, e.g. by vapor deposition, sputtering, galvanizing, plasma coating or painting.

The core metal layer and the electroconductive connections can be formed from any conductive corrosion-resistant metals or alloys. Cr—Ni steels can be used, for example. Other suitable materials are known to those skilled in the art.

The invention also relates to a method of fabricating bipolar plates by shaping a metal layer to form the electroconductive connections and subsequently encapsulating or sleeving the metal layer with the plastic. In addition, the bipolar plate can be fabricated by injection molding or compression molding the plastic to the desired shape and subsequently coating the surfaces with the metal to form the metal contacting means.

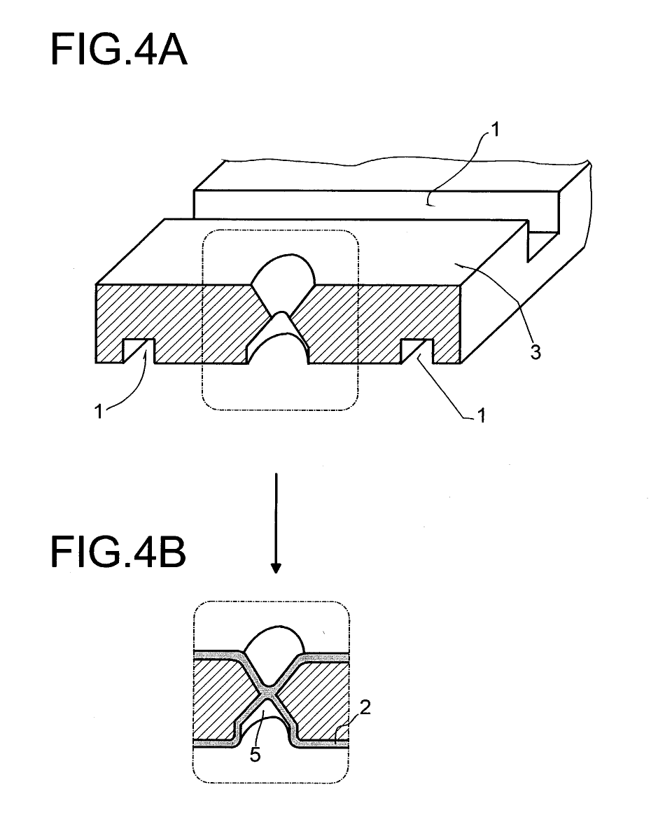

In a specifically preferred embodiment, plastic plates are employed for preparing the bipolar plates which show openings with a peaked narrowing. FIG. 4a shows an example of this type of plastic plate. By subsequently coating this plastics plate with a desired metal according to one of the above mentioned processes at the narrowing there is an increased material deposition so that a metal plug/corel is formed which closes the opening in the plastics plate and secures the electrical contact between the two surfaces (FIG. 4b). By employing the described plastics plates in one operation step ready-to-use bipolar plates may be prepared with non-coating methods.

In FIGS. 4a and 4b an example of a suitable geometry of the plastics plate is shown. FIG. 4a shows the plastics plate without a coating, whereas FIG. 4b shows the plastics plate in the coated state. The reference signs in the figures denote the following:

1. gas channels

2. conductive coating

3. plastics material

4. electrically conducting connection (contact)

The three-dimensional design in particular, making use of the plastic material, by virtue of injection molding permits simple fabrication even of complex geometric structures.

The bipolar plates according to the invention are generally used in fuel cell stacks comprising a plurality of individual cells. Such fuel cell stacks are fabricated by bipolar plate, gas distributor layer, catalyst layer, polymer membrane, catalyst layer and gas distributor layer being repeatedly stacked on top of one another, an individual cell being present each time between two bipolar plates. In addition, terminal current collectors and end plates are added. The stacked elements of the fuel cell stack are connected and sealed. For sealing purposes, elastomer seals can be applied in the border region of the bipolar plates according to the invention, or a seam geometry can be molded on, directly from the plastic, for subsequent welding, cementing or spray welding.

In the first case, sealing is effected by the plates being pressed firmly together. In the second case, the plates can be welded or cemented to one another. Welding can be carried out via any suitable techniques, e.g. by ultrasonic, heated-tool, vibration or laser welding. The individual elements of the fuel cells can alternatively be joined together and sealed by cementing or spray welding.

Alternatively, the fuel cell stack can also be sealed and joined together by the entire plate stack being encapsulated in an injection-molding process using suitable polymer materials.

A molded-on elastomer seal can be formed, e.g., in a two-component injection-molding process at the same time as the plastic layer.

Providing a raised circumferential rim with a molded-on weld geometry is particularly effective in permitting the elements to be joined together cost-effectively and gas-tightly to form a fuel cell stack.

The fuel cell stacks according to the invention can be used e.g. as a power supply in mobile and stationary apparatuses. As well as for domestic supplies they lend themselves, in particular, to the power supplies of vehicles such as land craft, watercraft and aircraft and of self-sufficient systems such as satellites.

The fuel cell stacks according to the invention are preferably stable in a temperature range of from −40 to +120° C., the working temperature being in the range, in particular, around 100° C. Thermostabilization can be achieved by suitable cooling media which communicate with at least part of the stack.

The bipolar plates according to the invention bring together an advantageous combination of low weight, good electroconductivity, gas-tightness or sealability, and gas-channel design.

1. A bipolar plate for PEM fuel cells comprising a core metal layer and two nonconductive plastic layers bilaterally overlying the metal layer and enclosing it, which form the surfaces of the bipolar plates, the metal layer having one or more electroconductive connections to both surfaces and the plastic layers being equipped with superficial gas transport channels.

2. A bipolar plate for PEM fuel cells made of nonconductive plastic which is equipped on both surfaces with gas transport channels and which, except for its edge region, is metal coated, the bilateral metal coatings being electroconductively connected through the plastic via one or more metal contacting means.

3. A bipolar plate as claimed in claim 1, wherein the plastic layers on both surfaces, except for their edge regions, are equipped with metal coatings which are electroconductively connected to the electroconductive connections.

4. A bipolar plate as claimed in any one of claims 1 to 3, wherein an elastomer seal is applied in the edge region of at least one of the surfaces or a seam geometry is integrally molded from the plastic for subsequent welding, cementing or spray welding.

5. A bipolar plate as claimed in any one of claims 1 to 4, wherein the plastics employed are selected from polyamides, polybutylenterephthalate, polyoxymethylene, polysulfone, polyethersulfone, polyphenyleneoxide, polyetherketone, polypropylene, polyester, ethylene-propylene-copolymers, unsaturated polyester resins, phenolformaldehyde resins.

6. A method of fabricating bipolar plates as claimed in claim 1 by shaping a metal layer to form the electroconductive connections and subsequently spray coating the metal layer with the plastic.

7. A method of fabricating bipolar plates as claimed in claim 2 by injection molding the plastic to the desired shape and subsequently coating the surfaces with the metal to form the metal contacting means.

8. A fuel cell stack comprising a plurality of fuel cells which include bipolar plates as claimed in any one of claims 1 to 15.

9. A method of fabricating fuel cell stacks as claimed in claim 8 by repeated stacking of bipolar plates, gas distributor layer, catalyst layer, polymer membrane, catalyst layer and gas distributor layer and respective terminal current collectors and end plates, bonding the layers and sealing them to produce the fuel cell stack.

10. The use of fuel cell stacks as claimed in claim 9 as a power supply in mobile and stationary apparatuses.
